(19) United States
(12) Patent Application Publication
(10) Pub. No.: US 2011/0242722 A1
(43) Pub. Date: Oct. 6, 2011

(54) CONTROL SYSTEM

(75) Inventors: Akira Yamada, Tokyo (JP); Yuuichi Kumazawa, Tokyo (JP); Tomoya Nakata, Tokyo (JP); Katsumi Morikawa, Tokyo (JP)

(73) Assignee: YAMATAKE CORPORATION, Tokyo (JP)

(21) Appl. No.: 13/072,942

(22) Filed: Mar. 28, 2011

(30) Foreign Application Priority Data
Mar. 30, 2010 (JP) 2010-079502

(51) Int. Cl. H01H 47/22

(52) U.S. Cl. 361/166

(57) ABSTRACT

First through third relays are connected in series, and a load 4 does not operate unless all are in the ON state. This enables the prevention of failures such as spilling of fuel due to a malfunction of the load, even when there is a fault in any of the first through third relays.

### CROSS REFERENCE TO RELATED APPLICATIONS

The present application claims priority under 35 U.S.C. §119 to Japanese Patent Application No. 2010-079502, filed Mar. 30, 2010, which is incorporated herein by reference.

### FIELD OF TECHNOLOGY

The present invention relates to a control system for controlling combustion in a combustion furnace.

### BACKGROUND OF THE INVENTION

In systems provided with combustion furnaces, such as boiler systems, conventionally there have been known control device systems wherein combustion has been controlled through controlling an electric current through interconnection cables for various structural elements for controlling the combustion of a combustion furnace, such as a fuel valve or an ignition transformer. While typically electromagnetic relays have been used in controlling the various structural components, such as the fuel valve, there is a danger in that a fault in an electromagnetic relay, such as the welding of the relay contact point, may cause a fuel spill, or the like. Given this, many technologies have been proposed for safety, such as redundant relays, the measurement of voltages on the load side of the relay contact point to detect welding, and the like (See, for example, Japanese Unexamined Patent Application Publication S62-007329 and Japanese Unexamined Patent Application Publication 2009-168404).

However, when a simple redundant relay is provided, it has not then possible to handle situations where faults occur in both relays. Additionally, in the technology for measuring the voltage on the load side, there is the danger of the load malfunctioning when performing operations such as testing on one side when the other side is welded. Because of this, there have long been the need for control systems capable of preventing malfunctions easily.

Given this, the object of the present invention is to provide a control system able to prevent malfunctions easily.

### SUMMARY OF THE INVENTION

In order to solve the problem such as set forth above, the control system according to the present invention includes a power supply unit for supplying power; at least one load driven by the power that is supplied; a first electromagnetic relay, provided for each load, connected in series with the power supply unit; a second electromagnetic relay connected in series with the power supply unit and the first electromagnetic relay; a third electromagnetic relay connected in series with the power supply unit, the first electromagnetic relay, and the second electromagnetic relay; and a control unit for outputting driving signals for controlling the driving of the first electromagnetic relay, the second electromagnetic relay, and the third electromagnetic relay.

The control system set forth above further comprises a detecting unit for detecting the driving of the first through third electromagnetic relays, and outputting the detection results to the control unit, where the control unit may detect faults in the first through third electromagnetic relays based on the detection results from the detecting unit based on the outputted driving signals.

The present invention makes it possible to prevent a malfunction of the load through not providing power to the load unless all the electromagnetic relays are driven, through the use of the simple structure of connecting to the first through third electromagnetic relays in series.

### BRIEF DESCRIPTION OF THE DRAWINGS

FIG. 1 is a diagram illustrating schematically a structure of a control system according to the present invention.

FIG. 2 is a diagram for explaining a fault detecting operation in a control system according to the present invention.

FIG. 3 is a diagram illustrating a specific example of a control system according to the present invention.

### DETAILED DESCRIPTION OF THE INVENTION

A form of embodiment according to the present invention will be explained in detail below based on the drawings.

Structure of the Combustion Control System

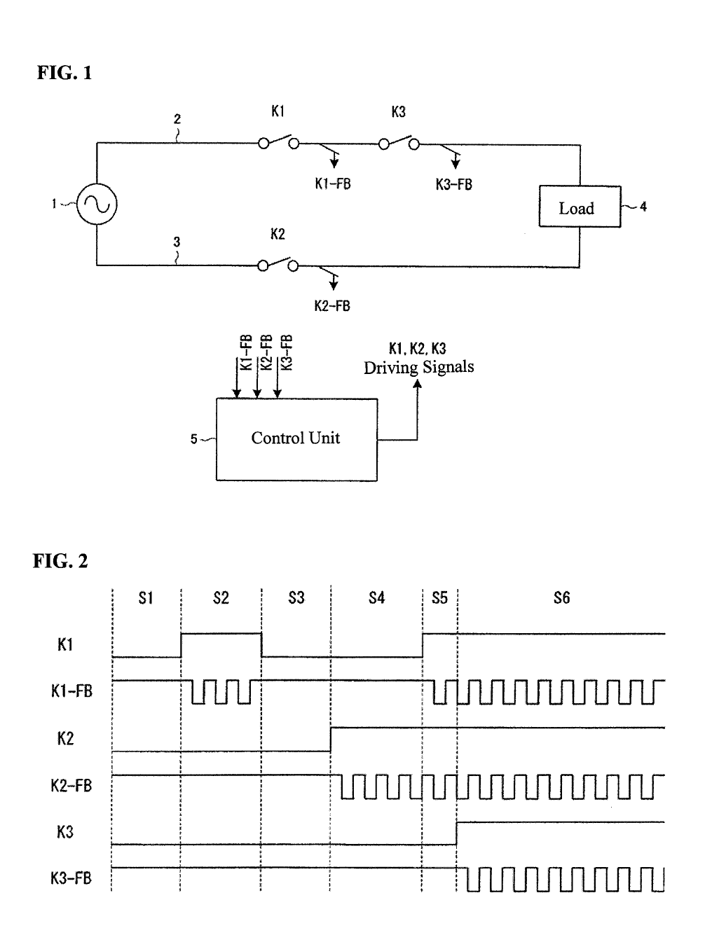

As illustrated in FIG. 1, the combustion control system according to the present form of embodiment comprises: a power supply 1; a toad 4 that is connected in series with the power supply 1 through two connecting wires 2 and 3; a first relay K1 and a third relay K3 that are connected in series with the connecting wire 2; and a second relay K2 connected in series with the connecting wire 3.

The first relay the second relay K2, and the third relay K3 are structured from well-known electromagnetic relays having mechanical contact points. Of these, the first and second relays K1 and K2 are relays for emergency shutoff, and when a fault has occurred in the combustion control system, the contact points open (goes into an OFF state), cutting off the current to the load 4, but, under normal circumstances, the contact points are closed (in the ON state). On the other hand, the third relay K3 is a relay for normal control, and is to control the driving of the load 4 through switching between the ON state and the OFF state. In first through third relays K1 through K3 of this type, the contact points go into the ON state when a driving signal is inputted from the control unit 5, and the contact points go into the OFF state when no driving signal is inputted. Moreover, detecting circuits for detecting the operations are provided for the first through third relays K1 through K3, and the detecting results (K1-FD, K2-FD, and K3-FD) are outputted to the control unit 5.

The load 4 is a structural element for controlling a combustion furnace, such as a pilot valve, a main valve, an ignition transformer, or the like. This type of load 4 operates when a current is supplied from the power supply 1.

The control unit 5 is structured from electric circuits that control the opening/closing of the contact points of the first through third relays K1 through K3 through outputting driving signals to the first through third relays K1 through K3. Additionally, the control unit 5 performs a fault detecting operation for detecting faults based on the driving signals outputted to the first through third relays K1 through K3 and the detection results inputted from the detecting circuits. The fault detecting operations will be described below.

It is possible to prevent failures, such as spilling of fuel through the malfunction of the load 4, even when there is a fault in any of the first through third relays K1 through K3, through the use of a structure, in this way, wherein the first through third relays K1 through K3 are connected in series so that the load 4 does not operate unless all are in the ON state.

Fault Detecting Operation

The fault detecting operation by the control unit 5 will be explained next in reference to FIG. 2. Note that this fault detecting operation is generally performed at startup.

First, when in a state wherein driving signals are not outputted to any of the first through third relays K1 through K3, the control unit 5 checks whether or not all of the first through third relays K1 through K3 are in the OFF state, from the detection results (K1-FD, K2-FD, and K3-FD) (Step S1).

If the first through third relays K1 through K3 are operating properly, the contact points will be in the OFF state, and thus will be nonconductive, unless a driving signal is inputted from the control unit 5. In this state, the detecting circuits of the first through third relays K1 through K3 should not detect a pulse waveform (in the case wherein the power supply 1 is AC) that indicates conductivity. Given this, the control unit 1 checks whether or not all of the first through third relays K1 through K3 are in the OFF state through checking whether or not the detection results indicate a pulse waveform. If any of the detection results for the first through third relays K1 through K3 indicate a pulse waveform, or in other words, if an ON state is confirmed, then the control unit 5 detects that there is a fault in either the relay that is in the ON state or in the detecting circuit for that relay. When this type of fault is detected, the control unit 5 stops all processes without advancing to the next step.

If it is confirmed that all of the first through third relays K1 through K3 are in the OFF state, then the control unit 5 outputs a driving signal to the first relay K1, and checks whether or not the first relay K1 is operating properly (Step S2).

If the first relay K1 is operating properly, then the contact point will go into the ON state when the driving signal is inputted from the control unit 5. At this time, the detecting circuit of the first relay K1 will detect the pulse waveform that indicates the conductive state, and this detection result (K1-FD)is outputted to the control unit 5. Consequently, when the pulse waveform is inputted as the detection result, the control unit 5 detects that the first relay K1 is operating properly. On the other hand, if, as the detection result, no pulse waveform is inputted, then the control unit 5 detects that there is a fault in either the first relay K1 or in the detecting circuit for the first relay K1. When a fault is detected in this way, the control unit 5 stops all processes, without advancing to the next step.

If the proper operation of the first relay K1 is confirmed, then the control unit 5, after stopping the output of the driving signal to the first relay (Step S3) outputs a driving signal to the second relay K2, check whether or not the second relay K2 is operating properly (Step S4).

If the second relay K2 is operating properly, then the contact point will go into the ON state when the driving signal is inputted from the control unit 5. At this time, the detecting circuit of the second relay K2 will detect the pulse waveform that indicates the conductive state, and this detection result (K2-FD) is outputted to the control unit 5. Consequently, when the pulse waveform is inputted as the detection result, the control unit 5 detects that the second relay K2 is operating properly. On the other hand, if, as the detection result, no pulse waveform is inputted, then the control unit 5 detects that there is a fault in either the second relay K2 or in the detecting circuit for the second relay K2. When a fault is detected in this way, the control unit 5 stops all processes, without advancing to the next step.

When it has been confirmed that the second relay K2 is operating properly, the control unit 5, in order to check whether or not the third relay K3 is operating properly, not only outputs a driving signal to the first relay K1 (Step S5), but also outputs a. driving signal to the third relay K3 (Step S6).

If the third relay K3 is operating properly when the first relay K1 and the second relay K2 are in the ON state, then the contact point thereof will go into the ON state, to become conductive, when the driving signal is inputted from the control unit 5. In this case, the detecting circuit for the third relay K3 will detect the pulse waveform that indicates the conductive state, and will output this as the detection result (K3-FB) to the control unit 5.

Consequently, if a pulse waveform is inputted as the detection result, the control unit 5 detects that the third relay K3 is operating properly. On the other hand, if no pulse waveform is inputted as the detection result, then the control unit 5 detects that there is a fault in either the third relay K3, or in the detecting circuit for the third relay K3. When a fault is detected in this way, the control unit 5 stops all processes without advancing to the next step.

The respective faults can be detected reliably through checking the operations of the first through third relays K1 through K3 through the procedure described above. Moreover, all processes are stopped when a fault is detected in either the relay or the detecting circuit, making it possible to prevent problems such as fuel spills.

Specific Example of a Combustion Control System

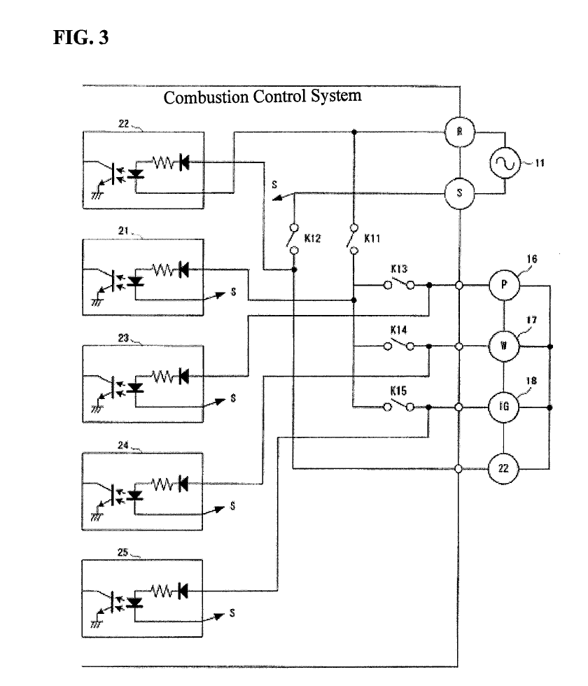

A specific example of a combustion control system is illustrated next in FIG. 3.

The combustion control system illustrated in FIG. 3 includes a first relay K11 that is connected in series with the R-phase side of a power supply 11; a second relay K12 that is connected in series with the S-phase side of the power supply 11; and third through fifth relays K13 through K15 that are connected in series between the first relay K11 and the second relay K12. In this type of combustion control system, a pilot valve 16 is connected to the third relay K13, a main valve 17 is connected to the fourth relay K14, and an ignition transformer 18 is connected to the fifth relay K15.

The first through third relays K11 through K15 are structured from well-known electromagnetic relays having mechanical contact points. Of these, the first and second relays K11 and the K12 are relays for emergency cutoff, and the contact points thereof go into the OFF state when a fault occurs in the combustion control system, to cut off the power to the pilot valve 16, the main valve 17, and the ignition transformer 18, but normally the contact points are in the closed state (the ON state), On the other hand, the third through fifth relays K13 through K15 are relays for normal control, and they control the operation of the pilot valve 16, the main valve 17, and the ignition transformer 18, connected thereto, through switching between the ON state and the OFF state. In this type of first through fifth relays K11 through K15, the contact points go into the ON state when control signals are inputted from a control device (not shown), and the contact points go into the OFF state when no driving signal is inputted. Additionally, detecting circuit 21 through 25, made out of circuits that are provided with photocouplers, are provided in the first through fifth relays K11 through K15 to detect the operations of the corresponding relays, and output the detection results to the control device.

The pilot valve 16 is provided with a fuel pipe that supplies fuel to a sub-burner that is provided within the combustion furnace, and is structured from a well-known valve for controlling the supply of fuel to the sub-burner, This type of pilot valve 16 is driven through the application of power by the contact points of the first through third relays K1 through K13 going into the ON state.

The main valve 17 is provided with a fuel pipe that supplies filet to a main burner that is provided within the combustion furnace, and is structured from a well-known valve for controlling the supply of fuel to the main burner. This type of main valve 17 is driven through the application of power by the contact points of the first, second, and fourth relays K11, K12, and K14 going into the ON state.

The ignition transformer 18 is structured from a well-known ignition transformer that controls the ignition of the main burner and the sub-burner. This type of ignition transformer 18 is driven by the application of power when the contact points of the first, second, and fifth relays K11, K12, and K15 go into the ON state.

The control device is structured from electric circuits fur controlling the opening/closing of the contact points of the first through fifth relays K11 through K15 through outputting driving signals to the first through fifth relays K11 through K15. Furthermore, a fault detecting operation for detecting faults in the first through fifth relays K11 through K15 is performed in the same manner as the fault detecting operation explained in reference to FIG. 2, based on the driving signals outputted to the first through fifth relays K11 through K15 and the detection results inputted from the detecting circuits 21 through 25.

Failures such as spilling of fuel can be prevented even when there is a fault in any of the first through fifth relays K11 through K15, through the use of a structure wherein, in this way, the first through fifth relays K11 through K15 are connected in series and not operating the respective loads if any of these is not turned ON. Additionally, the respective faults can be detected accurately through the fault detecting operations for the first through fifth relays 11 through 15 being performed by the control device. Furthermore, when a fault is detected in any of the relays or detecting circuits, all of the processes are stopped, thus preventing failures such as the spilling of fuel.

The present invention can be applied to various types of devices and systems that comprise electromagnetic relays, such as boiler systems.

1. A control system comprising:
a power supply unit for supplying power;
at least one load driven by the supplied power;
a first electromagnetic relay, provided for each load, connected in series with the power supply unit;
a second electromagnetic relay connected in series with the power supply unit and the first electromagnetic relay;
a third electromagnetic relay connected in series with the power supply unit, the first electromagnetic relay, and the second electromagnetic relay; and
a control unit for outputting driving signals for controlling the driving of the first electromagnetic relay, the second electromagnetic relay, and the third electromagnetic relay.

2. A control system as set forth in claim 1, further comprising:
a detecting unit for detecting the driving of the first through third electromagnetic relays, and for outputting the detection results to the control unit; wherein:
the control unit detects a fault in the first through third electromagnetic relay based on an outputted driving signal and based on a detection result from the detecting unit.
